(19) United States
(12) Patent Application Publication
(10) Pub. No.: US 2024/0329436 A1
(43) Pub. Date: Oct. 3, 2024

(54) Optical Waveguide Device, and Optical Modulation Device and Optical Transmission Apparatus Using Same

(71) Applicant: SUMITOMO OSAKA CEMENT CO., LTD., Tokyo (JP)

(72) Inventors: Katsutoshi KONDO, Tokyo (JP); Junichiro ICHIKAWA, Tokyo (JP)

(73) Assignee: SUMITOMO OSAKA CEMENT CO., LTD., Tokyo (JP)

(21) Appl. No.: 18/391,264

(22) Filed: Dec. 20, 2023

(30) Foreign Application Priority Data
Mar. 30, 2023 (JP) 2023-054914

(51) Int. Cl. G02F 1/035

(52) U.S. Cl. CPC G02F 1/035

(57) ABSTRACT

An optical waveguide device includes a first substrate including a first optical waveguide and a low refractive index layer covering the first optical waveguide and being formed of a material having a lower refractive index than a refractive index of the first optical waveguide, and a second substrate joined to the first substrate and including a rib type optical waveguide which is a second optical waveguide and is formed of a material having an electro-optic effect, in which the first optical waveguide and the second optical waveguide have parts optically coupled to each other, and in plan view of the optical waveguide device, a protruding portion is formed in the second substrate in a boundary portion where the first optical waveguide overlaps with the second substrate, and a thickness of the second substrate in the protruding portion is set to be thinner than a thickness of the second substrate in the second optical waveguide.

### CROSS-REFERENCE TO RELATED APPLICATIONS

This application claims the benefit of Japanese Patent Application No. 2023-054914 filed Mar. 30, 2023, the disclosure of which is herein incorporated by reference in its entirety.

### BACKGROUND OF THE INVENTION

### Field of the Invention

The present invention relates to an optical waveguide device, and an optical modulation device and an optical transmission apparatus using the same, and particularly to an optical waveguide device in which a first substrate on which a first optical waveguide is formed is joined to a second substrate on which a rib type optical waveguide that is a second optical waveguide is formed, and in which the first optical waveguide and the second optical waveguide are optically coupled to each other, and an optical modulation device and an optical transmission apparatus using the same.

### Description of Related Art

In recent years, in creating an optical waveguide device for optical communication or the like, a Si waveguide has been used in an optical waveguide (refer to Yikai Su, etc., “Silicon Photonic Platform for Passive Waveguide Devices: Materials, Fabrication, and Applications”, Advanced Materials Technologies. 1901153 (2020)). Since a CMOS process is used for the Si waveguide, the Si waveguide has scalability and is advantageous for achieving a low cost. In addition, the Si waveguide can also be combined with a light-receiving element formed of Ge/Si. Meanwhile, as a disadvantage, the Si waveguide cannot be used within a visible light range, and a modulation control is difficult to perform such that phase modulation is performed by causing a current to flow through the Si waveguide.

Thus, a novel platform in which silicon nitride (SiN) or thin film LiNbO₃ (TFLN; thin film LN) is used as an optical waveguide core has been reviewed (refer to Abdul Rahim, etc., “Expanding the Silicon Photonics Portfolio With Silicon Nitride Photonic Integrated Circuits”, Journal of Lightwave Technology, Vol. 35, No. 4, pp 639 (Feb. 15, 2017) and Mian Zhang, etc., “Integrated Lithium Niobate Electro-optic Modulators: When performance meets scalability”, Optica, Vol. 8, No. 5, pp 652 (2021)). A light source, phase modulation, reception, optical combining and branching (power combining and branching, wavelength combining and separation, polarization combining and separation, and the like) are essential for integration of optical functions. Since optimal materials for these configurations are different from each other, a method of integrating different types of materials has been developed.

Joining between different types of materials can also be formed using epitaxial growth. In recent years, optical function integration using a combination of materials that cannot be epitaxially grown has been implemented using a direct joining method of joining materials of which surfaces are flattened. In the optical function integration, a device in which optical combining and branching is integrated with phase modulation has been developed by integrating a silicon nitride (SiN) waveguide with TFLN.

In Sean Nelan, etc., “Ultra-high Extinction Dual-output Thin-film Lithium Niobate Intensity Modulator”, arXiv: 2207.02608v1 (Jul. 6, 2022), phase modulation is implemented without processing LN into a waveguide, by forming a SiN waveguide on TFLN. This method has weak optical confinement of the optical waveguide, compared to a monolithic TFLN modulator (refer to Abdul Rahim, etc., “Expanding the Silicon Photonics Portfolio With Silicon Nitride Photonic Integrated Circuits”, Journal of Lightwave Technology, Vol. 35, No. 4, pp 639 (Feb. 15, 2017)). Thus, a bending radius is approximately a few hundred μm, which is large, and a drive voltage (VI) is also high. However, productivity is secured by processing SiN that is easily processed, without processing LiNbO₃ (LN) that is a material having hard processability (it is difficult to perform dry etching).

Meanwhile, it has been suggested to establish both of phase modulation similar to that of LN in the related art and easy processability, mass production, and size reduction of the Si waveguide by replacing a phase modulation part of an optical modulator using Si with phase modulation using an electro-optic effect of LN or the like (refer to Shihao Sun, etc., “Hybrid Silicon and Lithium Niobate Modulator”, IEEE Jounal of selected topics in Quantum Electronics, Vol. 27, No. 3, pp 3300112 (May/June 2021)). A refractive index of Si is approximately 3.45 and is significantly higher than that of LN, which is approximately 2.14. In a case where a dimension of the Si waveguide is increased, an optical confinement effect as the optical waveguide is further increased. A light distribution can be polarized to be present only inside the Si waveguide and is difficult to receive effects of light scattering and the like based on structural changes of other materials near the Si waveguide. Consequently, an optical loss in an end portion of a TFLN substrate disposed on a substrate including the Si waveguide can be suppressed.

FIG. 1 is a plan view illustrating an example in which a second substrate 2 of TFLN or the like including a second optical waveguide 20 is disposed to overlap on a first substrate 1 including a first optical waveguide 10 such as the Si waveguide. Cross section views taken along dot-dashed lines IIA-IIA, IIB-IIB, and IIC-IIC in FIG. 1 are illustrated in FIGS. 2A to 2C. The first optical waveguide 10 is a core portion and is covered with a low refractive index layer 11 (clad portion) formed of a material having a lower refractive index than a refractive index of a material constituting the optical waveguide. In addition, in order to maintain mechanical strength, the first optical waveguide is supported by a holding substrate 12, as necessary. A rib type optical waveguide obtained by setting a part of the second substrate to be higher than its surroundings is used as the second optical waveguide 20.

In a plan view of an optical waveguide device as in FIG. 1, it is configured to provide a part 100 in which a width of the first optical waveguide is widened in a boundary portion between the first optical waveguide 10 and the second substrate 2 (an edge portion of the second substrate), in order to increase the optical confinement effect and suppress the optical loss caused by an effect of the edge portion of the second substrate 2.

In addition, an optical transition between the Si waveguide and a TFLN waveguide is made by decreasing a cross section dimension of the Si waveguide on a high refractive index side to enlarge the light distribution and cause a light wave to transition to the TFLN waveguide. Consequently, the optical transition between the Si waveguide and the TFLN waveguide can be made at a low loss (refer to Peter O. Weigel, etc., “Bonded Thin Film Lithium Niobate Modulator on a Silicon Photonics Platform Exceeding 100 GHz 3-dB Electrical Modulation Bandwidth”, Optics Express, Vol. 26, No. 18, pp. 23728 (Sep. 3, 2018)). Thus, in a first optical waveguide 101 that enters under the second substrate, the width of the optical waveguide is set to be narrowed in a tapered shape at a position overlapping with the second optical waveguide 20, as illustrated in FIG. 1.

Issues of the Si waveguide include its unavailability in a wavelength of 1.1 μm or lower because the Si waveguide is opaque in the wavelength, and inability to input high-intensity light into the Si waveguide because a phenomenon such as two-photon absorption occurs.

Thus, combining the SiN waveguide with the TFLN can provide an optical waveguide device that can be used up to a visible light range and that can perform phase modulation based on a change in strength of an electric field used in a LN optical modulator can be provided. Of course, since dry etching processing technology of SiN has also been established, productivity is also high like that of the Si waveguide.

However, a refractive index of SiN is approximately 2.00 and is also close to the refractive index of LN (approximately 2.14). Thus, even in a case where a dimension of the SiN waveguide that is the first optical waveguide is increased in the edge portion of the TELN, the SiN waveguide receives the effect of the TFLN. In addition, it is difficult to simply apply a structure used in the Si waveguide to the optical transition between the SiN waveguide that is the first optical waveguide and the rib type optical waveguide 20 of the TELN that is the second optical waveguide. For example, while it is also considered to remove surroundings of the rib type optical waveguide 20 as much as possible to thin or narrow a width dimension of the second substrate 2, this requires high processing accuracy and causes an increase in a cost or a decrease in a yield related to manufacturing.

In addition, as illustrated in FIG. 2C, in forming the rib type optical waveguide 20 on the TFLN that is the second substrate on the first substrate 1, the second substrate 2 is joined to the first substrate 1 as illustrated in FIG. 3A, and then a resist pattern PR1 is formed to cover a position at which the second optical waveguide is formed or a part not to be etched in the first substrate 1, as in FIG. 3B.

Particularly, in the edge portion of the TFLN near which the first optical waveguide is disposed, a resist material is disposed to cover (overhang) the edge portion. In a case where a part of the Si waveguide or the SiN waveguide that is the first optical waveguide is damaged by etching, a significant optical loss occurs.

Consequently, as illustrated in FIG. 3C, a protruding portion 22 having the same height as the rib type optical waveguide 20 is formed in the edge portion of the TFLN. FIG. 4 is a plan view, and the protruding portion 22 is formed in the edge portion of the second substrate 2 including a boundary portion between the second substrate 2 and the first optical waveguide 10 (100). FIG. 5 is a cross section view taken along dot-dashed line V-V in FIG. 4.

As an effect of the protruding portion 22, in a case where the first optical waveguide is the Si waveguide, a configuration of the part 100 in which the width of the optical waveguide is widened increases the optical confinement effect, and the optical loss can be suppressed. However, in a case where the first optical waveguide is the SiN waveguide, it is difficult to address the issue with the configuration of only the part 100 in which the width is widened.

### SUMMARY OF THE INVENTION

An object to be addressed by the present invention is to address the above issue and to provide an optical waveguide device that can make an optical transition between both waveguides at a low loss even in a case where a difference in a refractive index between both waveguides is decreased, such as between a SiN waveguide and a rib type optical waveguide of TFLN. Furthermore, an optical modulation device and an optical transmission apparatus using the optical waveguide device are provided.

In order to address the object, an optical waveguide device of the present invention, and an optical modulation device and an optical transmission apparatus using the same of the present invention have the following technical features.

(1) An optical waveguide device includes a first substrate including a first optical waveguide and a low refractive index layer that covers the first optical waveguide and that is formed of a material having a lower refractive index than a refractive index of the first optical waveguide, and a second substrate that is joined to the first substrate and that includes a rib type optical waveguide which is a second optical waveguide and which is formed of a material having an electro-optic effect, in which the first optical waveguide and the second optical waveguide have parts optically coupled to each other, and in a plan view of the optical waveguide device, a protruding portion is formed in the second substrate in a boundary portion in which the first optical waveguide overlaps with the second substrate, and a thickness of the second substrate in the protruding portion is set to be thinner than a thickness of the second substrate in the second optical waveguide.

(2) In the optical waveguide device according to (1), a length of the protruding portion in a propagation direction of a light wave propagating through the first optical waveguide may be 2 μm or lower.

(3) In the optical waveguide device according to (1), a width of the first optical waveguide in the boundary portion may be set to be wider than a width of the first optical waveguide positioned on a front stage or a rear stage of the boundary portion.

(4) In the optical waveguide device according to (1), a difference in a refractive index between the first optical waveguide and the second optical waveguide may be 0.8 or lower.

(5) In the optical waveguide device according to (4), the first optical waveguide may be formed of SiN, and the second substrate may be formed of lithium niobate.

(6) An optical modulation device includes the optical waveguide device according to any one of (1) to (5), a case accommodating the optical waveguide device, and an optical fiber through which a light wave is input into the first optical waveguide or output from the first optical waveguide.

(7) In the optical modulation device according to (6), the second substrate may include a modulation electrode for modulating a light wave propagating through the second optical waveguide, and an electronic circuit that amplifies a modulation signal to be input into the modulation electrode may be provided inside the case.

(8) An optical transmission apparatus includes the optical modulation device according to (7), a light source that inputs a light wave into the optical modulation device, and an electronic circuit that outputs a modulation signal to the optical modulation device.

In the present invention, an optical waveguide device includes a first substrate including a first optical waveguide and a low refractive index layer that covers the first optical waveguide and that is formed of a material having a lower refractive index than a refractive index of the first optical waveguide, and a second substrate that is joined to the first substrate and that includes a rib type optical waveguide which is a second optical waveguide and which is formed of a material having an electro-optic effect, in which the first optical waveguide and the second optical waveguide have parts optically coupled to each other, and in a plan view of the optical waveguide device, a protruding portion is formed in the second substrate in a boundary portion in which the first optical waveguide overlaps with the second substrate, and a thickness of the second substrate in the protruding portion is set to be thinner than a thickness of the second substrate in the second optical waveguide. Thus, an optical loss of the first optical waveguide caused by an edge portion of the second substrate can be suppressed. Accordingly, an optical waveguide device that can make an optical transition between both waveguides at a low loss even in a case where a difference in a refractive index between both waveguides is decreased, such as between a SiN waveguide and a rib type optical waveguide of TFLN, can be provided. Furthermore, an optical modulation device and an optical transmission apparatus using the optical waveguide device can be provided.

### BRIEF DESCRIPTION OF THE DRAWINGS

FIG. 1 is a plan view illustrating an example of an optical waveguide device.

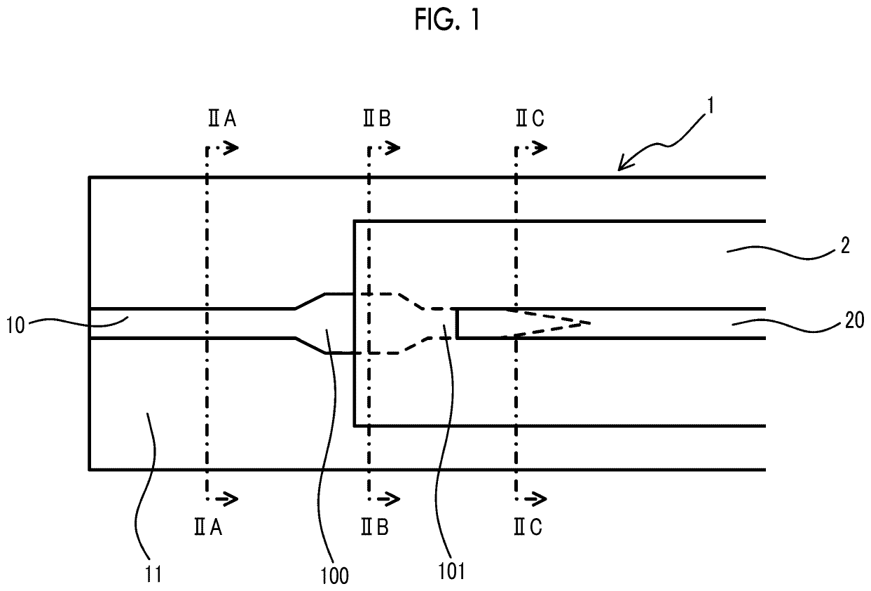

FIGS. 2A to 2C are cross section views of the optical waveguide device in FIG. 1. FIG. 2A is a cross section view taken along dot-dashed line IIA-IIA, FIG. 2B is a cross section view taken along dot-dashed line IIB-IIB, and FIG. 2C is a cross section view taken along dot-dashed line IIC-IIC.

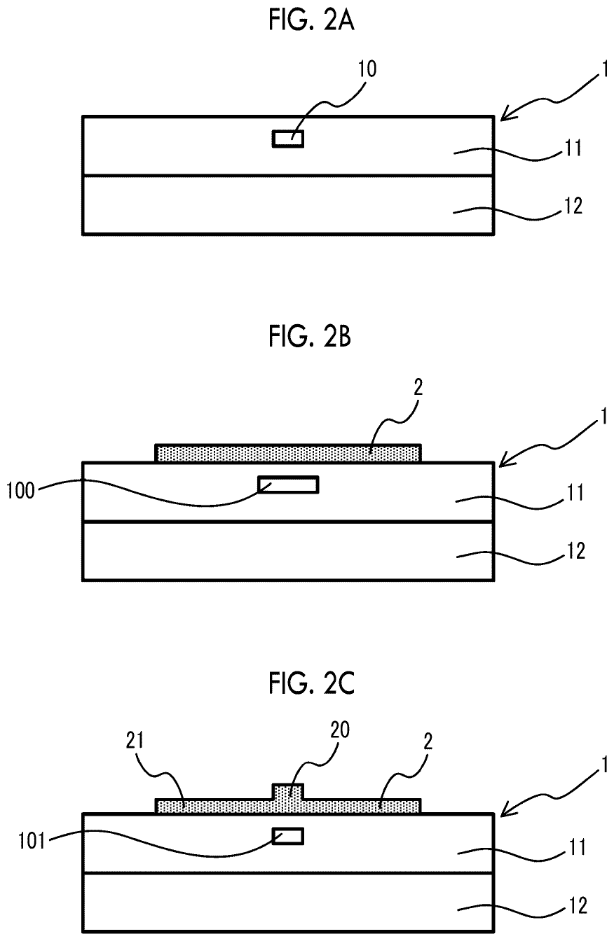

FIGS. 3A to 3C are diagrams illustrating a part of a manufacturing process of the optical waveguide device, particularly illustrating a state where a protruding portion is formed on a second substrate.

FIG. 4 is a plan view of the optical waveguide device illustrated in FIG. 3C.

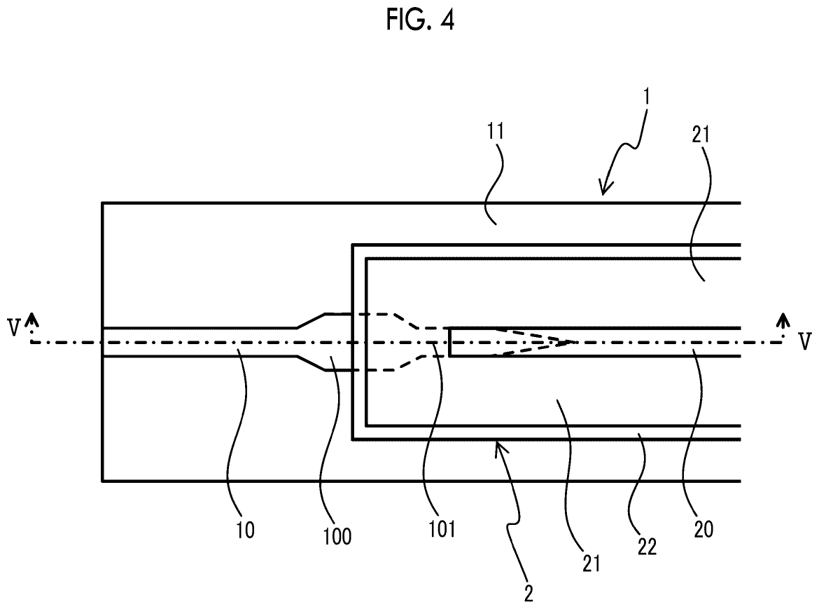

FIG. 5 is a cross section view taken along dot-dashed line V-V in FIG. 4.

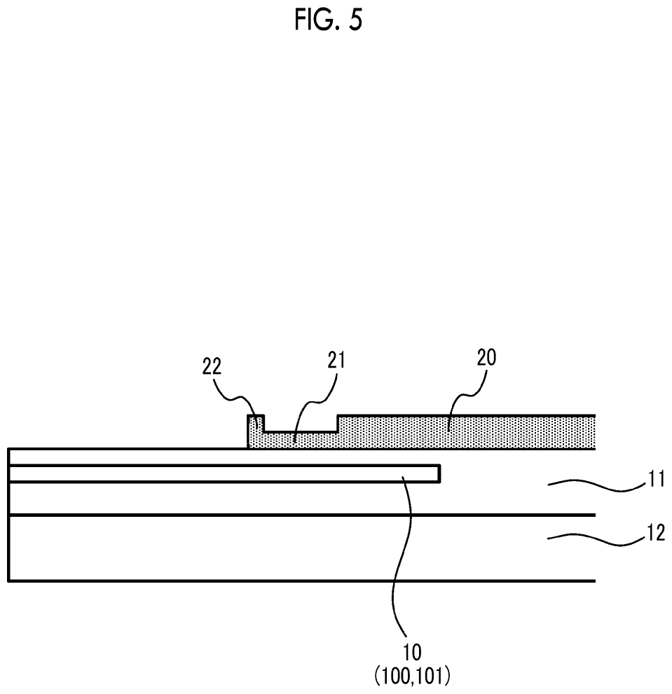

FIG. 6 is a plan view illustrating an example of an optical waveguide device of the present invention.

FIG. 7 is a cross section view taken along dot-dashed line VII-VII in FIG. 6.

FIGS. 8A to 8C are diagrams illustrating a part (1) of a manufacturing process according to the optical waveguide device of the present invention.

FIGS. 9A to 9D are diagrams illustrating a part (2) of the manufacturing process according to the optical waveguide device of the present invention.

FIGS. 10A and 10B are diagrams for describing an example in which two optical waveguides are optically coupled in the optical waveguide device of the present invention.

FIG. 11 is a diagram illustrating an example of a change of an effective refractive index between the two optical waveguides in a propagation direction of light.

FIGS. 12A to 12C are diagrams for describing a simulation model in a case where TFLN is mounted on an upper side of a SiN waveguide.

FIG. 13 is a graph illustrating a relationship between a width of the SiN waveguide and a thickness of the TFLN.

FIG. 14 is a diagram illustrating a change of an overlap integral (Loss) based on a change of a clearance between the SiN waveguide and the TELN and a change in the thickness of the TELN in a case where a height (thickness) of the SiN waveguide is constant.

FIGS. 15A to 15D are diagrams for describing a simulation model of an optical transition between the SiN waveguide and a rib type optical waveguide (TFLN).

FIGS. 16A and 16B are graphs illustrating a change of an optical loss in a change of a wavelength.

FIGS. 17A to 17C are diagrams for describing a simulation model for evaluating an effect of a protruding portion of an edge portion of the TFLN.

FIG. 18 is a diagram illustrating the effect of the protruding portion of the TFLN.

FIGS. 19A to 19E are diagrams for describing a part of a manufacturing process using a wafer constituting a plurality of optical waveguide devices (chips).

FIGS. 20A to 20E are diagrams for describing a part of a manufacturing process of the optical waveguide device in which a second substrate (TFLN) is used in an action portion of an optical modulator.

FIG. 21 is a diagram illustrating an example of an optical transmission apparatus of the present invention.

### DETAILED DESCRIPTION OF THE INVENTION

Hereinafter, an optical waveguide device of the present invention will be described in detail using preferred examples.

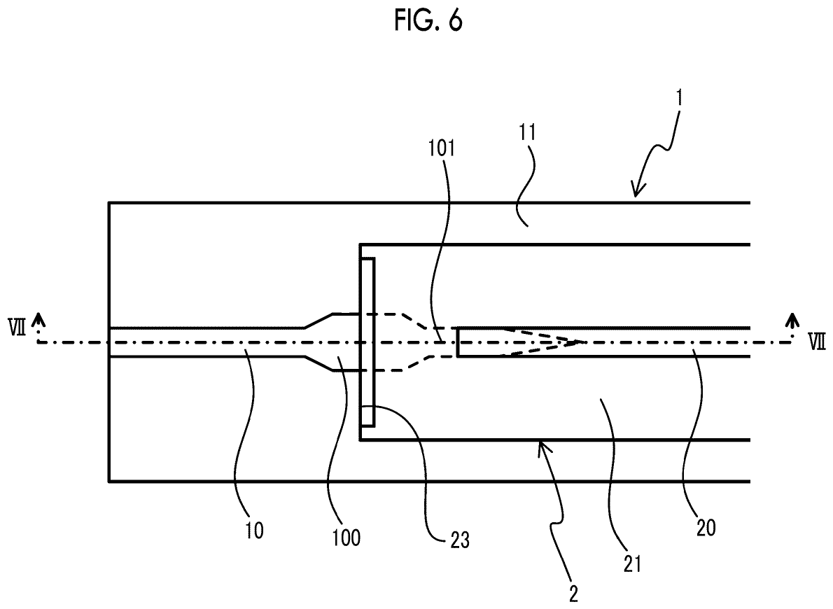

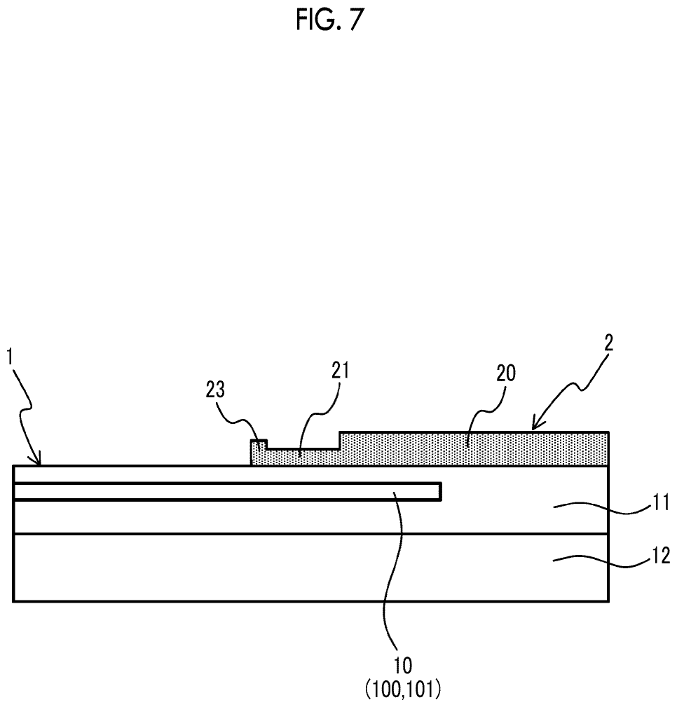

As illustrated in FIGS. 6 and 7, the optical waveguide device of the present invention includes a first substrate 1 including a first optical waveguide 10 and a low refractive index layer 11 that covers the first optical waveguide 10 and that is formed of a material having a low refractive index than a refractive index of the first optical waveguide, and a second substrate 2 that is joined to the first substrate 1 and that includes a rib type optical waveguide 20 which is a second optical waveguide and which is formed of a material having an electro-optic effect, in which the first optical waveguide 10 and the second optical waveguide 20 have parts optically coupled to each other, and in a plan view of the optical waveguide device, a protruding portion 23 is formed in the second substrate in a boundary portion in which the first optical waveguide overlaps with the second substrate, and a thickness of the second substrate 2 in the protruding portion 23 is set to be thinner than a thickness of the second substrate 2 in the second optical waveguide 20.

While a SiN waveguide as the first optical waveguide and TFLN as the second substrate will be mainly described in the optical waveguide device of the present invention, the present invention is not limited to these materials. For example, a Si waveguide can also be used as the first optical waveguide. However, the optical waveguide device of the present invention can be more suitably used in a case where a difference in a refractive index between the material used in the first optical waveguide and the material used in the second optical waveguide is small. For example, considering that a refractive index of SiN is within a range of 1.5 to 2.0 and a refractive index of LN is 2.1 to 2.3, it is more preferable to use the present invention in a case where the difference in the refractive index is 0.8 or lower. While the case of using SiN will be mainly described below, a refractive index of pure SiN can be adjusted to 1.5 to 2.0 depending on density. However, a film having low density is penetrated by moisture, and the refractive index or the like is likely to change. Thus, silicon oxynitride (SiON) having an adjustable composition can be included in SiN in the present invention.

FIG. 6 is a plan view illustrating an example of the optical waveguide device of the present invention, and FIG. 7 is a cross section view taken along dot-dashed line VII-VII in FIG. 6. In the case of forming the first optical waveguide 10 as the SiN waveguide, SiN is disposed in the first optical waveguide (core portion), and a clad portion is formed of a material having a lower refractive index than the refractive index of SiN of the core portion to cover surroundings of the first optical waveguide. In the first substrate 1, for example, the core portion of the optical waveguide is formed of SiN, and the clad portion 11 is formed of SiO₂ to cover the core portion 10. The clad portion 11 will be referred to as the low refractive index layer.

While the substrate including the first optical waveguide 10 is referred to as the first substrate 1 in the present invention, the first substrate can include not only the first optical waveguide 10 and the low refractive index layer 11 covering the first optical waveguide 10 but also a holding substrate 12 for increasing mechanical strength of the entire substrate. Si or SiO₂ can be used as the holding substrate.

A thin plate of lithium niobate (LN), lithium tantalate (LT), lead lanthanum zirconate titanate (PLZT), or the like that is a material having an electro-optic effect is used as the second substrate 2 to be joined to the first substrate 1. Hereinafter, TFLN will be mainly described.

The rib type optical waveguide 20 is formed on a surface of the second substrate 2 as the second optical waveguide. The first optical waveguide 10 and the second optical waveguide have parts that overlap with each other in a plan view as illustrated in FIG. 6 and are configured to make a transition of a light wave between the first optical waveguide and the second optical waveguide using the parts. Shapes of the overlapping parts will be described in detail later.

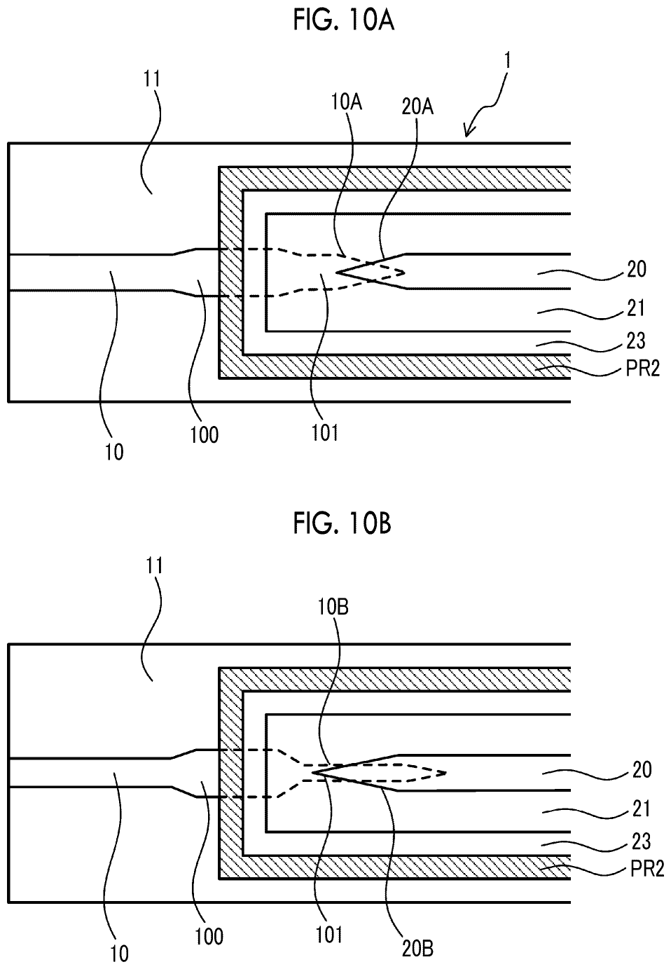

As a feature of the optical waveguide device of the present invention, as illustrated in FIG. 6, in a plan view of the optical waveguide device, the protruding portion 23 is formed in the second substrate 2 in a boundary portion in which the first optical waveguide 10 overlaps with the second substrate 2. As illustrated in FIG. 7, the thickness of the second substrate 2 in the protruding portion 23 is set to be thinner than the thickness of the second substrate 2 in the second optical waveguide 20. While a part in which the protruding portion 23 is formed is formed in only an edge portion of the second substrate near the first optical waveguide 10 in FIG. 6, the present invention is not limited thereto. For example, the protruding portion 23 can be formed in the entire edge portion of the second substrate as illustrated in FIGS. 10A and 10B.

In the optical waveguide device of the present invention, a height of the protruding portion 23 is decreased in order to suppress scattering of the light wave propagating through the first optical waveguide 10 by the protruding portion 23. Occurrence of an optical loss is suppressed by setting the height of the protruding portion 23 to be lower than a height of at least the second optical waveguide 20. In addition, by setting a part that is a part of the first optical waveguide 10 and that is disposed under the protruding portion 23 to have a higher effective refractive index than effective refractive indexes of other parts, optical confinement is strengthened. Accordingly, scattering of the light wave by the protruding portion can be reduced. Specifically, a width of the optical waveguide is set to be wide as illustrated by reference sign 100 in FIG. 6. In the present specification, the first optical waveguide is illustrated by reference sign 10, the part in which the width is widened near the edge portion of the second substrate is illustrated by reference sign 100, and the part of the first optical waveguide positioned under the second substrate is illustrated by reference sign 101.

Furthermore, as a shape of the protruding portion 23, a length of the protruding portion 23 in a propagation direction of the light wave propagating through the first optical waveguide 10 is preferably 2 μm or lower. By setting such a range, the optical loss can be further suppressed. Details will be described later.

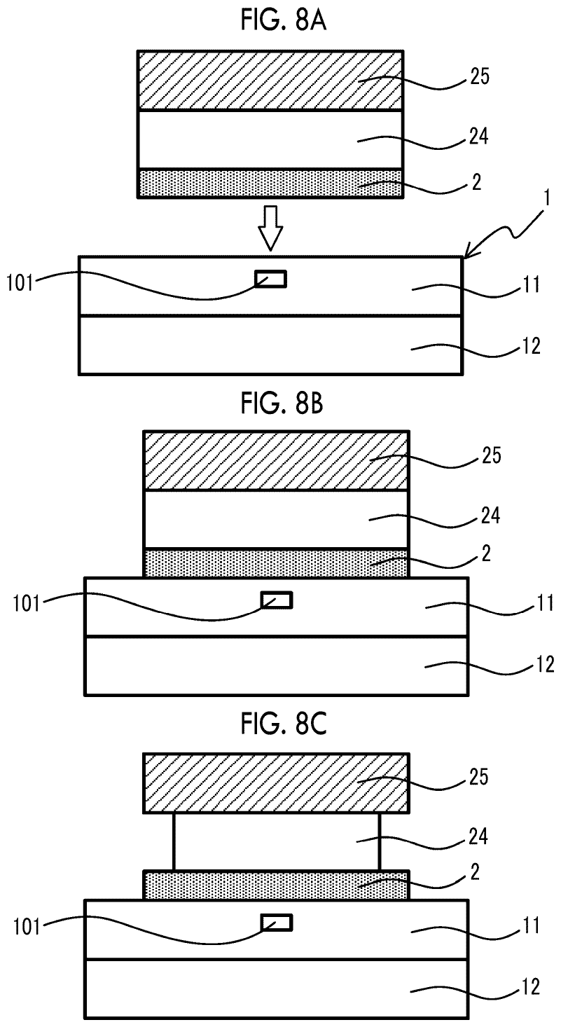

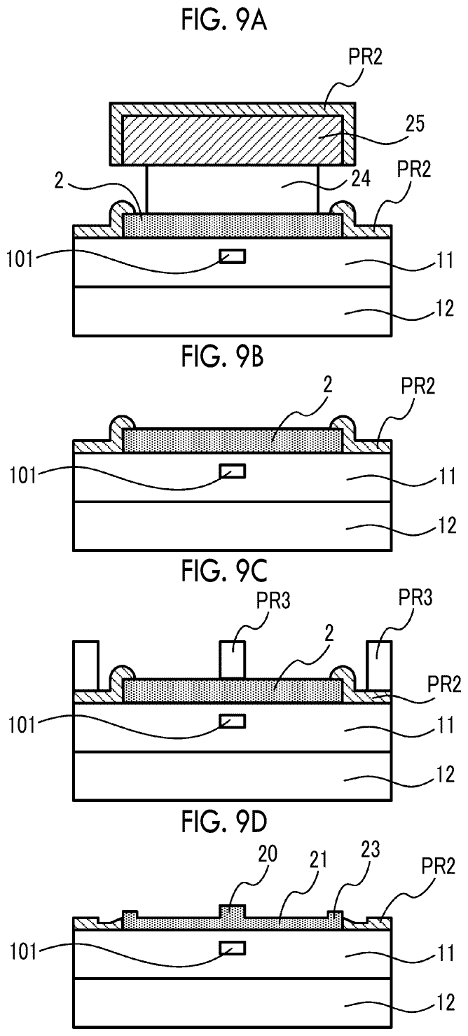

Next, a manufacturing process related to the optical waveguide device of the present invention will be described using FIGS. 8A to 8C and FIGS. 9A to 9D. The SiN waveguide and the TELN are used in the following optical waveguide device.

### Step 1

The first substrate 1 including the SiN waveguide illustrated on a lower side of FIG. 8A is prepared. The SiN 101 is covered with the low refractive index layer 11 and is supported by the holding substrate 12.

### Step 2

TELN having a thickness of approximately 0.5 μm is prepared as the second substrate 2. The TFLN is bonded to a holding member 25 through a release layer 24. Specific examples of a material of the release layer include WOx.

### Step 3

The SiN waveguide (first substrate) is joined to the TFLN (second substrate) (refer to FIGS. 8A and 8B). While a joining method may be either direct joining or resin adhesion, direct joining is described in FIG. 8B. Direct joining is also described in Peter O. Weigel, etc., “Bonded Thin Film Lithium Niobate Modulator on a Silicon Photonics Platform Exceeding 100 GHz 3-dB Electrical Modulation Bandwidth”, Optics Express, Vol. 26, No. 18, pp. 23728 (Sep. 3, 2018).

### Step 4

Side etching of the release layer 24 is performed using an appropriate chemical or the like (refer to FIG. 8C). In the case of performing side etching of WOx using a chemical, a liquid mixture of aqueous ammonia and aqueous hydrogen peroxide or the like is appropriate as an etching liquid. In addition, in the case of performing side etching via dry etching, fluorine-based gases such as SF₆ and XeF₂ can be used as an etching gas. At this point, while any side etching amount may be used, the side etching amount is desirably larger than or equal to a thickness of the release layer 24.

### Step 5

An appropriate processing suppression film PR2 is formed on the above sample (refer to FIG. 9A). As a matter required for forming the film, a deposition method having step coverage is required. Specifically, the deposition method is sputtering deposition, and “step coverage=film thickness of thinnest portion/film thickness of flat portion” (a ratio of the film thickness of the thinnest part to the film thickness of the flat portion) is set to approximately 0.5. While the step coverage of vacuum deposition is near 0, the step coverage can be increased by increasing a pressure during deposition. In a case where a material having high dry etching tolerance, described later, is used in deposition, the step coverage is preferably lower than 0.5.

Examples of a material used in the processing suppression film PR2 include a material with which an appropriate selection ratio is obtained during TFLN processing and a material that is not removed at the same time during side etching of the release layer. Specifically, in a case where the release layer is WOx, Cr or the like is suitably used. In addition, a product in which the processing suppression film is left after TFLN processing is also available. In this case, additional conditions for the film material include not causing optical absorption and having a lower refractive index than the refractive index of SiN or LN. As a specific material of the processing suppression film, Al₂O₃, SiO₂, HfO₂, GeO₂, or the like can be used. However, since the material of the processing suppression film varies depending on a dry etching condition of the TFLN, the present invention is not limited to the above materials. A thickness of the processing suppression film PR2 is required to be a thickness with which up to an inner side of a range including not only the SiN waveguide (SiN) but also a part of the low refractive index layer 11 functioning as the clad portion using SiN as the core portion is not processed by processing during formation of a TFLN waveguide. The processing suppression film PR2 on the edge portion of the TELN may have any thickness, and a state where the substrate 2 of TFLN is exposed after the TELN waveguide is formed is preferable.

### Step 6

The release layer 24 is removed with an appropriate chemical or the like, and the holding member is peeled (refer to FIG. 9B). Peeling can also be performed using the chemical used in STEP 4.

### Step 7

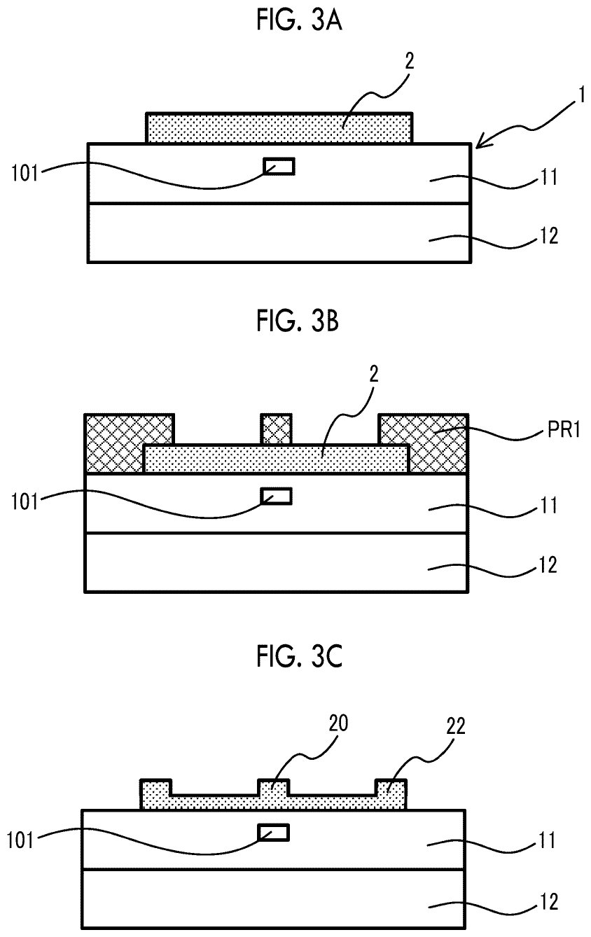

A resist pattern PR3 is formed by applying a resist on a substrate “SiN waveguide substrate with TFLN” obtained by joining the TFLN to the substrate (101, 11, 12) including the SiN waveguide 101. The pattern is positioned with respect to the SiN waveguide 101. Here, the resist PR3 is not required to cover (overhang) an outer peripheral portion of the TFLN (second substrate 2). The resist PR3 is a resist for protecting the TFLN and is a resist for forming the rib type optical waveguide 20 on the TELN (refer to FIG. 9C). For example, in the case of overhanging as in FIG. 3B, the thickness of the second substrate positioned under the resist PR3 is the same as the thickness of the second substrate in the rib type optical waveguide 20. This makes it difficult to set the protruding portion of the edge portion of the second substrate to have a lower height than the rib type optical waveguide, which is the feature of the optical waveguide device of the present invention.

### Step 8

The rib type optical waveguide 20 is formed on the TFLN by performing dry etching of the TFLN using the resist pattern PR3 as a mask (refer to FIG. 9D). Since the film thickness of the processing suppression film PR2 in the edge portion of the TFLN is thinner than the film thickness on the SiN waveguide, LN is exposed after the TFLN waveguide is formed. This state forms a magnitude relationship of “thickness of TFLN rib type optical waveguide 20”> “thickness of protruding portion 23 of TFLN”>thickness of TFLN processing part 21″ and is also a desirable state from the viewpoint of suppressing the optical loss of the optical waveguide.

FIG. 10A is a plan view illustrating a part of the optical waveguide device created through the above manufacturing process. A state where the processing suppression film PR2 is left on an outer side of the protruding portion 23 of the TFLN is illustrated. In addition, the thickness of the protruding portion 23 is thinner than the thickness of the rib type optical waveguide 20 and is thicker than that of the processing portion 21 that is mainly processed. Furthermore, even in a case where the SiN waveguide 10 having weak optical confinement is used, scattering of light near the edge portion of the TFLN is the same as that of the Si waveguide. Thus, a waveguide width (100) having strong optical confinement is used in a part of the SiN waveguide 10.

In the optical transition from the SiN waveguide 10 to the rib type optical waveguide 20 of the TFLN, the SiN waveguide width having a tapered shape 10A that is continuously narrowed decreases the effective refractive index, and the other rib type optical waveguide 20 of the TFLN having a tapered shape 20A that is conversely continuously widened increases the effective refractive index. In a case where both effective refractive indexes become equal, the optical transition is made.

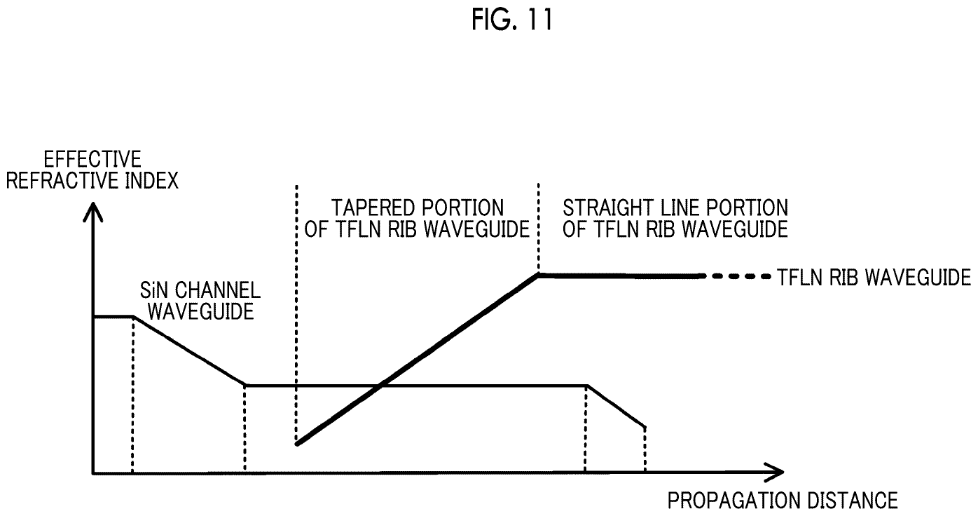

In the example in FIG. 10B, a structure considering manufacturing tolerance is provided, and a stable optical transition can be made even in a case where a positional relationship between the SiN waveguide 10 and the rib type optical waveguide 20 is slightly shifted in a right-left direction of FIG. 10B. A specific change in the width of the optical waveguide is illustrated in FIG. 11. In a tapered portion 20B of the rib type optical waveguide 20 of the TELN, the SiN waveguide 10 is an optical waveguide 10B of a constant width not having a change in the effective refractive index. A low-loss optical transition and the manufacturing tolerance can be secured by causing the effective refractive indexes of the waveguides to intersect with each other, as in FIG. 11.

Hereinafter, a specific design condition for implementing a low-loss optical transition between the SiN waveguide and the rib type optical waveguide of the TFLN will be described.

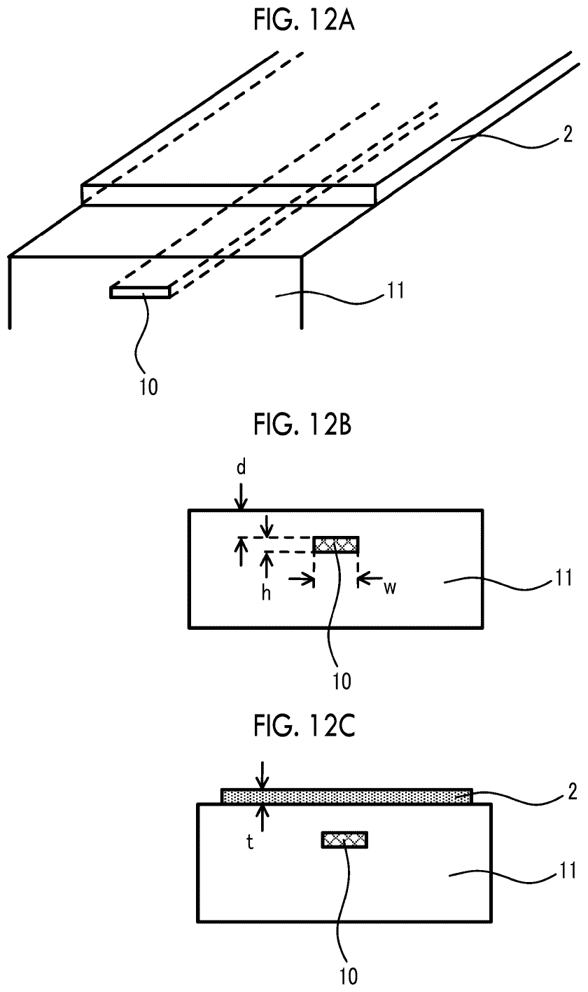

First, as illustrated in FIG. 12A, a structure in which the TFLN 2 is mounted on the SiN waveguide 10 in the middle of the SiN waveguide 10 is considered. In a case where light is input into the SiN waveguide, the refractive index rapidly changes in the edge portion of the TELN 2. Thus, light is scattered. The loss at this point can be calculated as an overlap integral of the light of which the wave is guided based on the refractive index distributions in FIG. 12B and FIG. 12C.

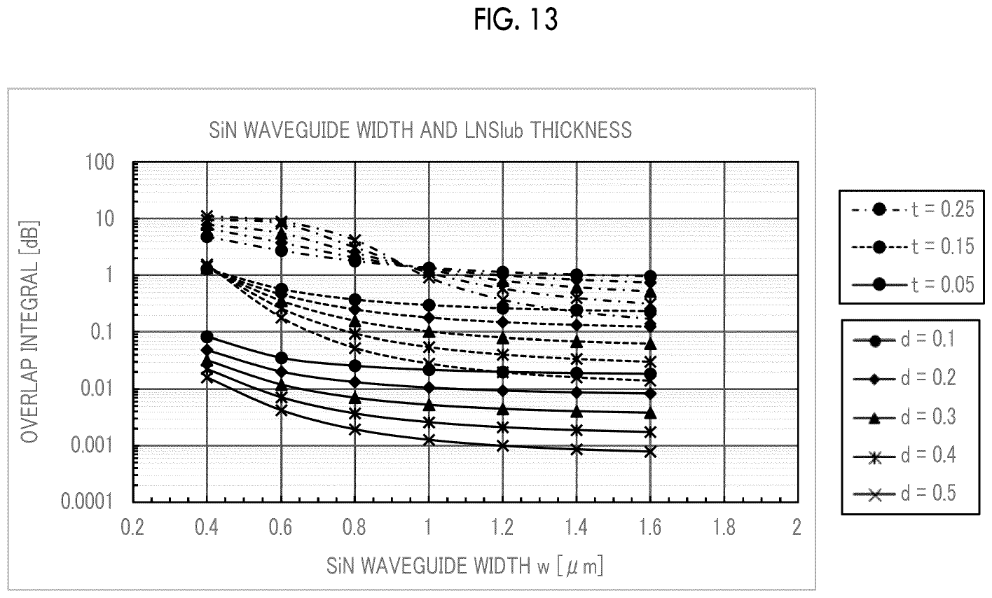

FIG. 13 is a result of the optical loss based on TFLN mounting calculated by fixing a SiN waveguide thickness (h) to 0.5 μm and using a SiN waveguide width (w), a clearance (d) between the SiN waveguide and the TFLN, and a thickness (t) of the TFLN as parameters that change within the following numerical value ranges. Calculation is performed using a wavelength of 1.55 μm and a TE mode.
w=0.4 to 1.6 μm
d=0.1 to 0.5 μm
t=0.05 to 0.25 μm

From FIG. 13, as the clearance d between the SiN waveguide and the TFLN is increased, interaction between the SiN waveguide and the TELN is decreased, and thus the optical loss is decreased. Similarly, as the thickness t of the TFLN is decreased, the optical loss is decreased. The point is that as the SiN waveguide width w is increased, the optical loss is decreased, and in a case where the SiN waveguide width w is 1.2 μm or greater, the optical loss has a constant value.

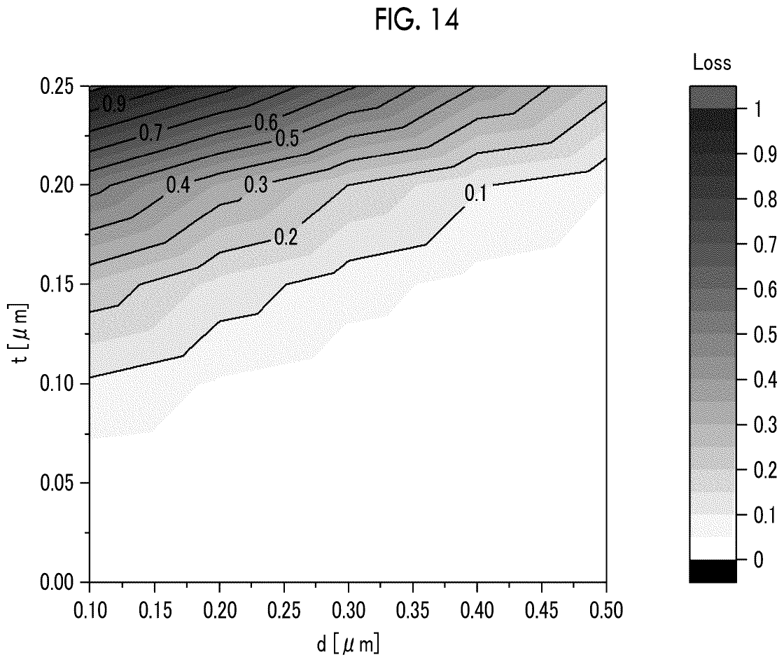

Thus, contour lines of the optical loss (overlap integral) in a case where the SiN waveguide width w is fixed to 1.4 μm and t and d are used as parameters are illustrated in FIG. 14.

In a case where the optical loss based on the TELN mounting is defined to be 0.1 dB or lower, the following relationship expression is established in a case where the line of 0.1 dB in FIG. 14 is approximated as a straight line.

$$\\ t \leq 0.29 d + 0.072$$

The refractive index of the SiN film can be changed by forming the SiN film to have a non-stoichiometric composition (SiNx, x≠1.33) or changing density. Furthermore, LN can also be formed to have a non-stoichiometric composition, and the refractive index of LN can be adjusted by impurity doping (Mg, Zn, or the like). Thus, the only correct condition in which the expression is established is that the SiN film has a stoichiometric composition and LN has a congruent-melting composition.

Next, a state where a rib structure is added to the TFLN is considered. A case where a directional coupler is used for optical connection between the SiN waveguide 10 and the rib type optical waveguide 20 of the TFLN will be described.

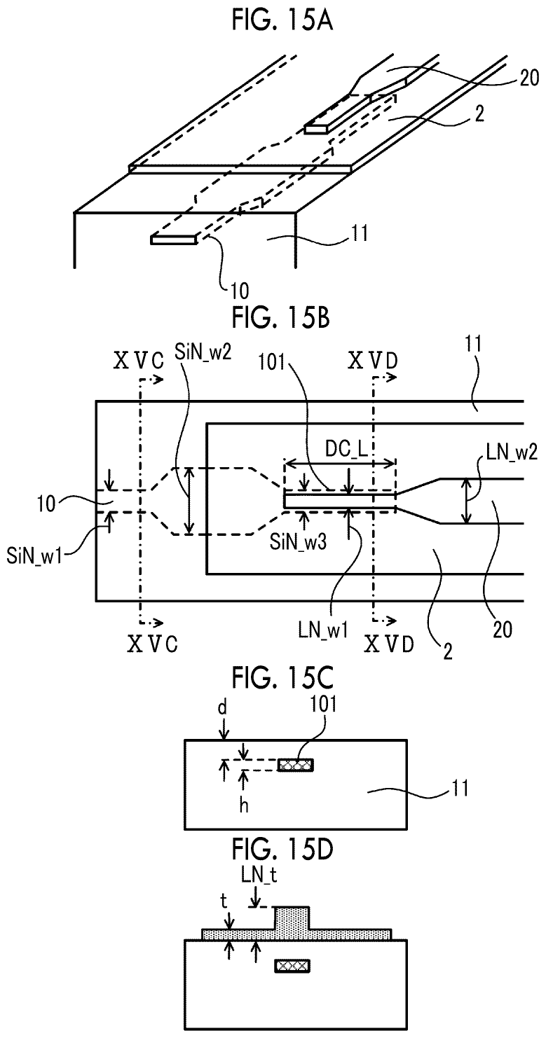

A perspective view of a simulated structure is illustrated in FIG. 15A. FIG. 15B is a plan view of the structure, and dimension symbols of each waveguide are also described. A width SiN_w1=0.8 μm of an optical input portion of the SiN waveguide is fixed, and the SiN waveguide width in the edge portion of the mounted TELN is increased to SiN_w2=1.4 μm. This is done in order to suppress the optical loss on the edge of the TFLN. Narrowing the SiN waveguide width in an inner side of the TELN mounting to SiN_w3 results in a state where light propagating through the SiN waveguide receives the effect of the TFLN.

In the rib type optical waveguide 20 of the TFLN in the upper part, a length of a region interacting with the SiN waveguide 10 (101) is denoted by DC_L, and a width of the rib waveguide is denoted by LN_w1. Then, light is confined within the waveguide by increasing the width of the rib type optical waveguide 20 to LN_w2=1.0 μm. Cross section views taken along dot-dashed lines XVC-XVC and XVD-XVD in FIG. 15B are illustrated in FIGS. 15C and 15D, respectively. The thickness h=0.5 μm of the SiN waveguide is fixed, and a thickness of an upper clad layer is denoted by d. A thickness LN_t=0.5 μm of the TELN corresponds to a thickness of a rib structure core portion.

In addition, a remaining thickness of the TELN in a part processed into the rib structure is denoted by t.

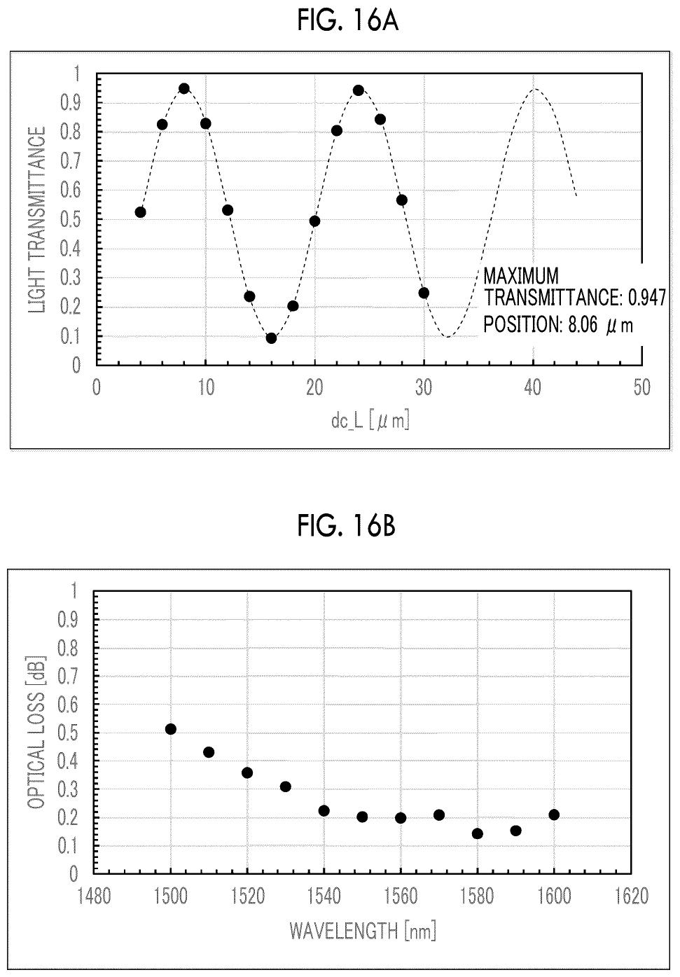

In this structure, a result of calculation by fixing SiN_w3=1.0 μm, LN_w1=0.75 μm, d=0.3 μm, and t=0.1 μm and using DC_L as a parameter is illustrated in FIG. 16A. Parameters used in calculation are illustrated in Table 1.

TABLE 1
Parameter Table

| Symbol | Value | Meaning |
|---|---|---|
| SiN_w1 | 0.8 μm | Input SiN Waveguide Width |
| SiN_w2 | 1.4 μm | SiN Waveguide Width in Boundary Portion of |
| | | TFLN Mounting |
| SiN_w3 | 1.0 μm | SIN Waveguide Width in Directional Coupling |
| | | Unit |
| DC_L | 8.0 μm | Coupling Length of Directional Coupler |
| LN_w1 | 0.75 μm | TFLN Rib Waveguide Width in Directional |
| | | Coupling Unit |
| LN_w2 | 1.0 μm | TFLN Rib Waveguide Width on Output Side |
| d | 0.3 μm | Clearance between SiN Waveguide and TFLN |
| | | Rib Waveguide Width |
| h | 0.5 μm | SiN Waveguide Thickness |
| LN_t | 0.5 μm | TFLN Rib Waveguide Thickness |
| t | 0.1 μm | Remaining Film Thickness of TFLN Rib |
| | | Waveguide |

A vertical axis in FIG. 16A denotes a value obtained by dividing an output light quantity (a light quantity of output light from the rib type optical waveguide of the TFLN) by an input light quantity (a light quantity of input light into the SiN waveguide). It is found that setting the coupling length DC_L=8.0 μm results in transmittance of 95% (0.2 dB). Wavelength dependence (1500 to 1600 nm) in the case of coupling length DC_L=8.0 μm is illustrated in FIG. 16B as a reference.

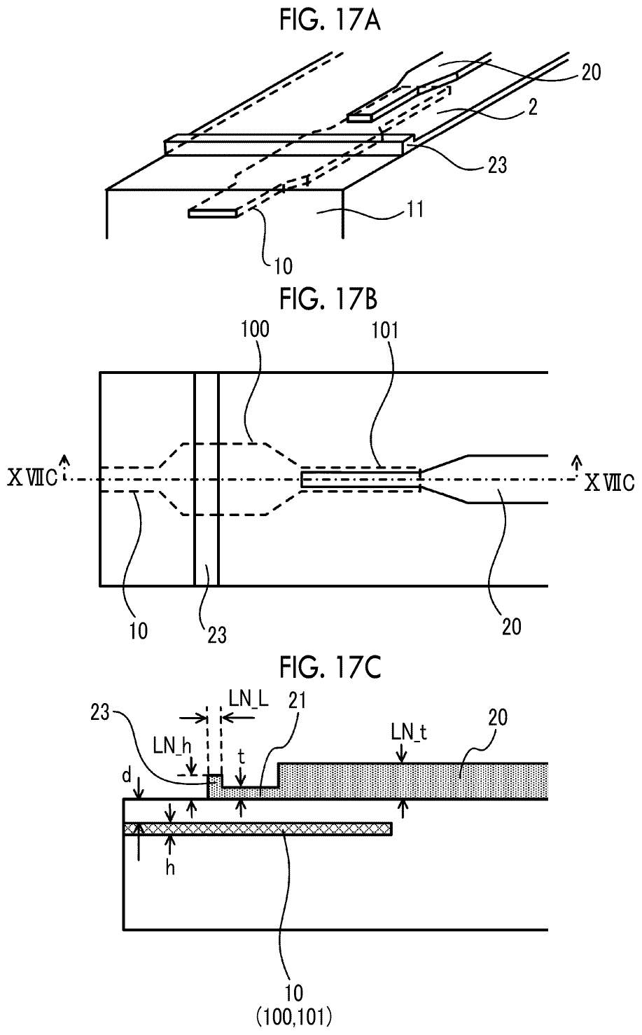

Furthermore, a case where a protruding portion is formed in the edge portion of the TFLN is considered. A perspective view of a simulated structure is illustrated in FIG. 17A. A plan view of the simulated structure is illustrated in FIG. 17B. A cross section view taken along dot-dashed line XVIIC-XVIIC in the plan view is illustrated in FIG. 17C. The dimension symbols used in FIGS. 15A to 15D are the same as those in FIGS. 17A to 17C, and only the protruding portion 23 of the edge portion of the TELN is different. As described in FIG. 17C, the protruding portion is described with a length LN_L and a thickness LN_h in the propagation direction of the light.

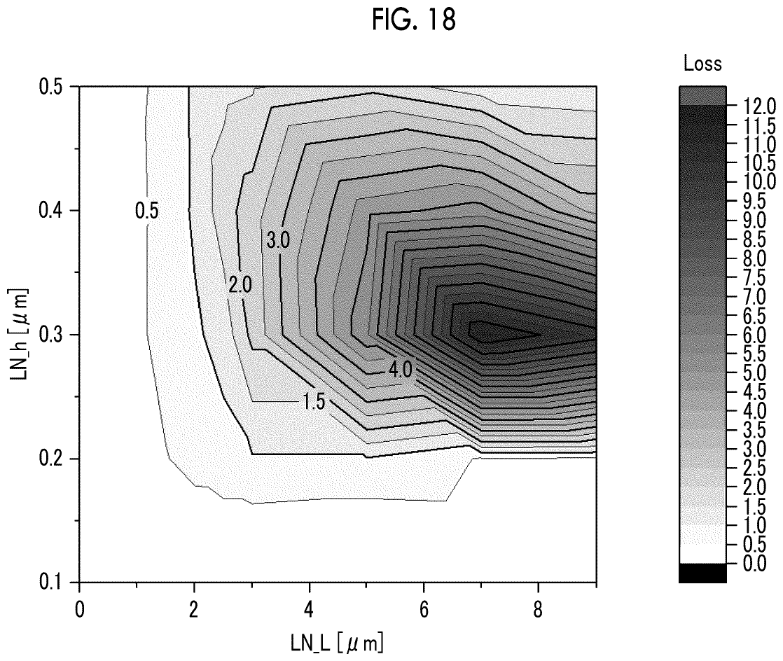

In this structure, a result of the optical loss calculated by fixing the parameters (Table 1) used in FIGS. 15A to 15D and using LN_h and LN_L as parameters is illustrated in FIG. 18. In a case where an upper limit of the optical loss is 0.5 dB, LN_h<0.17 μm or LN_L<1.2 μm is established. Furthermore, in a case where the upper limit of the optical loss is 1.0 dB, LN_h<0.21 μm or LN_L<2.0 μm is established. That is, the length of the SiN waveguide in the propagation direction of the light wave in the protruding portion 23 is preferably 2 μm or lower.

Joining between the SiN waveguide and the TELN at a chip level is described above. The manufacturing process used in the present invention can also be implemented at a wafer level. This will be described. Numbers of each step below are related to the numbers of the steps of the manufacturing process in FIGS. 8A to 8C and FIGS. 9A to 9D.

### Step 1

A substrate including the SiN waveguide is prepared.

### Step 2-1

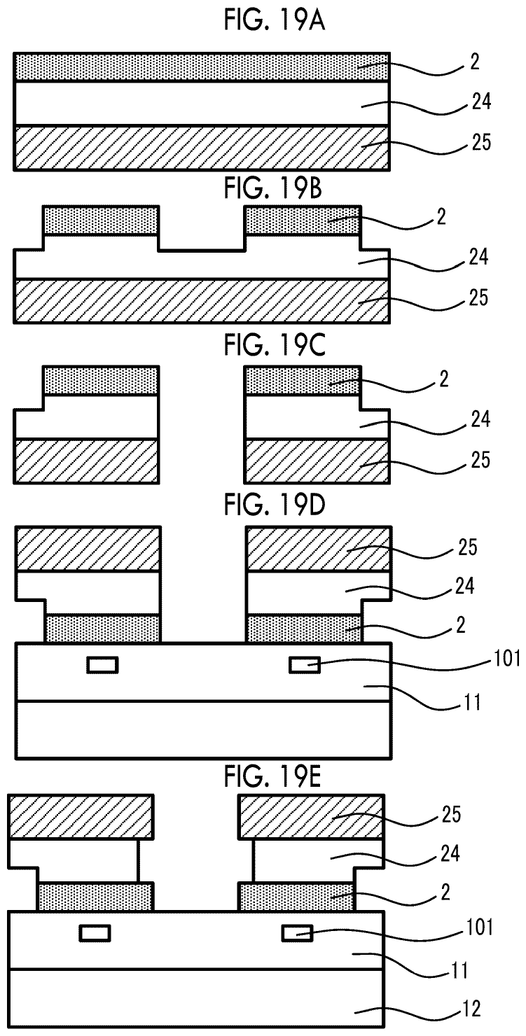

As illustrated in FIG. 19A, the TFLN 2 to which the release layer 24 is attached is prepared.

### Step 2-2

As in FIG. 19B, a through-hole is formed in a part corresponding to the edge of the TFLN. Si excavation processing, laser processing, or the like used in MEMS is suitable.

### Step 2-3

As in FIG. 19C, a non-required part of the holding member 25 supporting the TFLN 2 is removed using an appropriate method (dry etching, laser processing, or mechanical processing with a dicer or the like).

### Step 3

As in FIG. 19D, the above wafer is cleaned and then is bonded to a wafer with the SiN waveguide. At this point, the edge of the TFLN is adjusted to be in a part (refer to reference sign 100 in FIG. 6) in which the width of the SiN waveguide is wide.

### Step 4

As in FIG. 19E, side etching of the release layer 24 is performed through the through-hole.

### Step 5

The processing suppression film PR2 is deposited. (refer to FIG. 9A)

### Step 6

The release layer 24 is completely peeled. (refer to FIG. 9B)

### Steps 7 and 8

A hardly processable material PR3 is deposited, and the rib type optical waveguide 20, the protruding portion 23, and the like are processed (refer to FIGS. 9C and 9D). Then, an electrode is formed.

According to the above manufacturing process, it is understood that the optical waveguide device of the present invention can also be manufactured at the wafer level.

Next, a method of using the TELN in only an action portion (a part in which an electric field of the electrode acts on the optical waveguide) of a Mach-Zehnder type optical waveguide in using the optical waveguide device of the present invention as an optical modulator will be described.

### Step 1

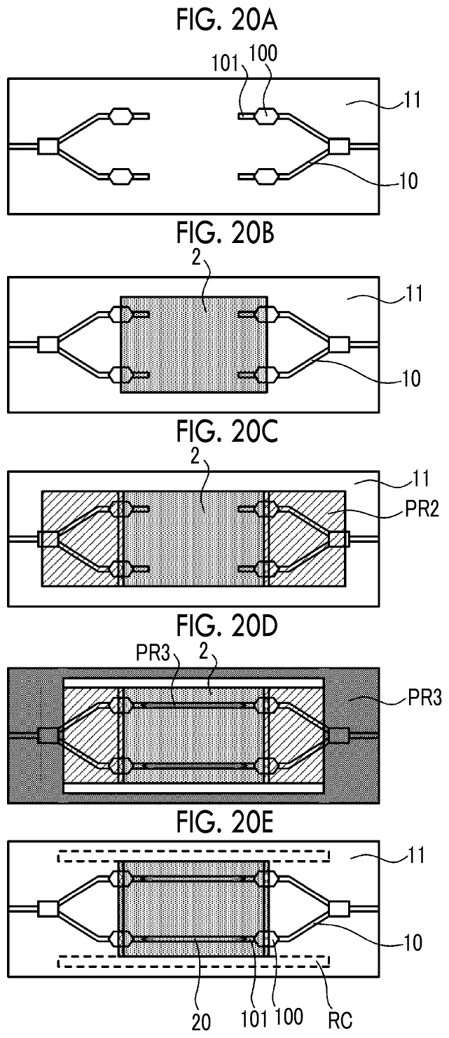

As in FIG. 20A, the SiN waveguide 10 is prepared.

### Steps 2 and 3

As in FIG. 20B, a substrate to which the TELN 2 is attached (includes the holding member and the release layer; referred to as a “substrate with TFLN”) is bonded to a substrate (includes the low refractive index layer 11) on which the SiN waveguide 10 is formed. At this point, a length of the part 100 in which the width of the SiN waveguide is large is the manufacturing tolerance with respect to a “dimension of the substrate with TFLN” and “bonding accuracy”.

### Steps 4, 5, and 6

Side etching of the release layer is performed, and the processing suppression film PR2 is deposited as in FIG. 20C. The release layer is removed, and the holding member is peeled.

### Step 7

The resist (hardly processable material) PR3 is patterned as in FIG. 20D. Positioning during patterning is performed with respect to a position at which the rib type optical waveguide is formed and to a part that is to be protected in the substrate on which the SiN waveguide is formed.

### Step 8

As in FIG. 20E, the TFLN is processed, and the processing suppression film PR2 and the hardly processable material PR3 are removed. While a state where recess portions RC are formed above and below an MZ structure is described, this part does not include the waveguide and thus may be processed without an issue.

Then, an electrode and the like are formed.

Next, examples of applying the optical waveguide device of the present invention to an optical modulation device and to an optical transmission apparatus will be described. While an example of a high bandwidth-coherent driver modulator (HB-CDM) will be used in the following description, the present invention is not limited to the example and can also be applied to an optical phase modulator, an optical modulator having a polarization combining function, an optical waveguide device in which a larger or smaller number of Mach-Zehnder type optical waveguides are integrated, a device joined to an optical waveguide device including other materials such as silicon, a device used as a sensor, and the like.

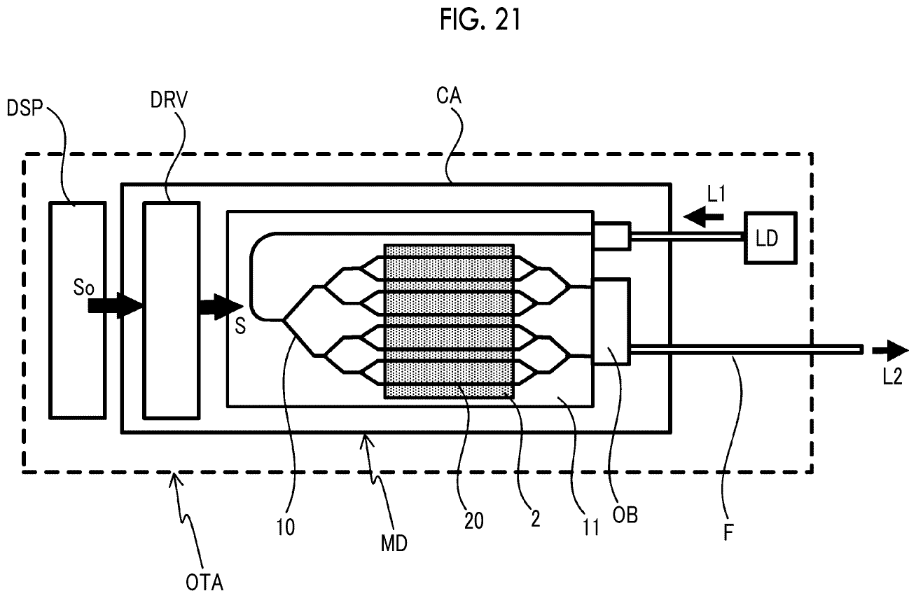

As illustrated in FIG. 21, the optical waveguide device includes the optical waveguide configured with the SiN waveguide 10 or with the rib type optical waveguide 20, and a control electrode (not illustrated) such as a modulation electrode that modulates the light wave propagating through the rib type optical waveguide 20. The optical waveguide device is accommodated inside a case CA. Furthermore, an optical modulation device MD can be configured by providing an optical fiber (F) through which the light wave is input into the optical waveguide or output from the optical waveguide. In FIG. 21, the optical fiber F is optically coupled to the SiN waveguide 10 inside the optical waveguide device using an optical block including an optical lens, a lens barrel, a polarization-combining part OB, and the like. The present invention is not limited to the optical fiber F in FIG. 21. The optical fiber may be introduced into the case through a through-hole that penetrates through a side wall of the case. The optical fiber may be directly joined to an optical component or to the substrate, or the optical fiber having a lens function in an end portion of the optical fiber may be optically coupled to the optical waveguide inside the optical waveguide device. In addition, a reinforcing member (not illustrated) can be disposed to overlap along an end surface of the substrate (includes the low refractive index layer 11) including the SiN waveguide in order to stably join the optical fiber or the optical block. In the polarization-combining part OB, a space system can be replaced with a waveguide by applying the waveguide structure described in Mian Zhang, etc., “Integrated Lithium Niobate Electro-optic Modulators: When performance meets scalability”, Optica, Vol. 8, No. 5, pp 652 (2021) to the SiN waveguide. Manufacturing and member costs can be suppressed.

An optical transmission apparatus OTA can be configured by connecting, to the optical modulation device MD, an electronic circuit (digital signal processor DSP) that outputs a modulation signal So causing the optical modulation device MD to perform a modulation operation. In order to obtain a modulation signal S to be applied to the optical waveguide device, it is required to amplify the modulation signal So output from the digital signal processor DSP. Thus, in FIG. 21, the modulation signal is amplified using a driver circuit DRV. The driver circuit DRV and the digital signal processor DSP can be disposed outside the case CA or can be disposed inside the case CA. Particularly, disposing the driver circuit DRV inside the case can further reduce a propagation loss of the modulation signal from the driver circuit.

While input light L1 of the optical modulation device MD may be supplied from an outside of the optical transmission apparatus OTA, a semiconductor laser (LD) can also be used as a light source as illustrated in FIG. 21. Output light L2 modulated by the optical modulation device MD is output to the outside through the optical fiber F.

As described above, according to the present invention, it is possible to provide an optical waveguide device that can make an optical transition between both waveguides at a low loss even in a case where a difference in a refractive index between both waveguides is decreased, such as between a SiN waveguide and a rib type optical waveguide of TFLN. Furthermore, it is possible to provide an optical modulation device and an optical transmission apparatus using the optical waveguide device.

What is claimed is:

1. An optical waveguide device comprising:
a first substrate including a first optical waveguide and a low refractive index layer that covers the first optical waveguide and that is formed of a material having a lower refractive index than a refractive index of the first optical waveguide; and
a second substrate that is joined to the first substrate and that includes a rib type optical waveguide which is a second optical waveguide and which is formed of a material having an electro-optic effect,
wherein the first optical waveguide and the second optical waveguide have parts optically coupled to each other, and
in a plan view of the optical waveguide device, a protruding portion is formed in the second substrate in a boundary portion in which the first optical waveguide overlaps with the second substrate, and a thickness of the second substrate in the protruding portion is set to be thinner than a thickness of the second substrate in the second optical waveguide.

2. The optical waveguide device according to claim 1,
wherein a length of the protruding portion in a propagation direction of a light wave propagating through the first optical waveguide is 2 μm or lower.

3. The optical waveguide device according to claim 1,
wherein a width of the first optical waveguide in the boundary portion is set to be wider than a width of the first optical waveguide positioned on a front stage or a rear stage of the boundary portion.

4. The optical waveguide device according to claim 1,
wherein a difference in a refractive index between the first optical waveguide and the second optical waveguide is 0.8 or lower.

5. The optical waveguide device according to claim 4,
wherein the first optical waveguide is formed of SiN, and the second substrate is formed of lithium niobate.

6. An optical modulation device comprising:
the optical waveguide device according to any one of claims 1 to 5;
a case accommodating the optical waveguide device; and
an optical fiber through which a light wave is input into the first optical waveguide or output from the first optical waveguide.

7. The optical modulation device according to claim 6,
wherein the second substrate includes a modulation electrode for modulating a light wave propagating through the second optical waveguide, and
an electronic circuit that amplifies a modulation signal to be input into the modulation electrode is provided inside the case.

8. An optical transmission apparatus comprising:
the optical modulation device according to claim 7;
a light source that inputs a light wave into the optical modulation device; and
an electronic circuit that outputs a modulation signal to the optical modulation device.
